(19) United States
(12) Patent Application Publication
(10) Pub. No.: US 2015/0368129 A1
(43) Pub. Date: Dec. 24, 2015

(54) FLUID TREATMENT APPARATUS

(71) Applicants: Yuu ZAMA, Kanagawa (JP); Toshiyuki MUTOH, Kanagawa (JP); Hideyuki MIYAZAWA, Kanagawa (JP); Makito NAKASHIMA, Kanagawa (JP); Shogo SUZUKI, Kanagawa (JP); Aya UTSUKI, Kanagawa (JP); Kenichi HAYAKAWA, Kanagawa (JP); Kimio AOKI, Kanagawa (JP); Shigeru YAMADA, Kanagawa (JP)

(72) Inventors: Yuu ZAMA, Kanagawa (JP); Toshiyuki MUTOH, Kanagawa (JP); Hideyuki MIYAZAWA, Kanagawa (JP); Makito NAKASHIMA, Kanagawa (JP); Shogo SUZUKI, Kanagawa (JP); Aya UTSUKI, Kanagawa (JP); Kenichi HAYAKAWA, Kanagawa (JP); Kimio AOKI, Kanagawa (JP); Shigeru YAMADA, Kanagawa (JP)

(21) Appl. No.: 14/729,176

(22) Filed: Jun. 3, 2015

(30) Foreign Application Priority Data
Jun. 18, 2014 (JP) 2014-125622

(51) Int. Cl. C02F 1/72; C02F 1/52; B01D 21/00

(52) U.S. Cl. CPC C02F 1/725; B01D 21/0051; C02F 1/5236; C02F 2101/363

(57) ABSTRACT

A fluid treatment apparatus for treating a target fluid is provided. The fluid treatment apparatus includes a reactor to decompose an organic substance contained in a mixed fluid of the target fluid with an oxidant by an oxidation reaction. The reactor includes a cylindrical base material, a catalyst, and a migration space. The catalyst accelerates the oxidation reaction of the organic substance, and is disposed along an inner periphery of the cylindrical base material. Into the migration space, solids precipitated in the oxidation reaction migrate in a longitudinal direction without accumulating.

### CROSS-REFERENCE TO RELATED APPLICATIONS

This patent application is based on and claims priority pursuant to 35 U.S.C. §119(a) to Japanese Patent Application No. 2014-125622, filed on Jun. 18, 2014 in the Japan Patent Office, the entire disclosure of which is hereby incorporated by reference herein.

### BACKGROUND

1. Technical Field

The present invention relates to a fluid treatment apparatus for treating a target fluid.

2. Description of the Related Art

Supercritical water oxidation apparatuses which decompose and detoxify persistent substances such as dioxins and PCB (polychlorinated biphenyl) and organic fluids such as human excrement, sewage, livestock excreta, and industrial effluent are known.

For example, a hydrothermal oxidation apparatus and a supercritical water oxidation apparatus each of which transforms a target fluid including an organic substance into a non-toxic substance, such as carbon dioxide, water, or an inorganic salt, by subjecting the target fluid to an oxidation reaction using supercritical water and an oxidant are known.

In such apparatuses, the reaction typically takes place under a pressure in a range of 25 to 50 MPa and a temperature in a range of 500° C. to 700° C.

Such apparatuses need to be resistant to high temperatures of about 500° C. to 700° C. and high pressures of about 25 to 50 MPa, which causes inevitable increase in their size and cost.

An apparatus which accelerates an oxidation reaction is also known. In this apparatus, a mixed fluid of high-temperature and high-pressure water, having a temperature equal to or greater than the critical temperature of water and a pressure lower than the critical pressure of water, with an oxidant is brought into contact with a catalyst in a reactor. This type of apparatus using catalyst is capable of causing an oxidation of persistent organic substances even at relatively low temperatures of about 250° C. to 500° C.

In addition, this apparatus is capable of treating the target fluid under a milder condition (e.g., under a pressure in a range of 0.5 to 20 MPa and a temperature in a range of 100° C. to 500° C.) compared to the supercritical water oxidation apparatus. This contributes to downsizing and cost reduction of the apparatus.

One known method of arranging catalyst involves arranging granular catalysts 102 inside a cylindrical reactor 100 in such a manner that the granular catalysts 102 intersect with the direction of flow of a fluid, as illustrated in FIG. 1A. In this case, the fluid is allowed to migrate through interstices between the catalysts 102 while contacting the catalysts 102 in the axial (longitudinal) direction of the reactor 100.

In this case, however, flow resistance is large and treatment efficiency is low. Another known method of arranging catalyst involves arranging a honeycomb structural catalyst 106 inside the reactor 100, as illustrated in FIG. 1B. The honeycomb structural catalyst 106 is formed by bonding multiple tubes 104 extending in the direction of flow of a fluid. Each of the tubes 104 has catalyst layers on its inner and outer peripheral surfaces.

In this case, the fluid is allowed to migrate within each tube. Therefore, flow resistance is smaller than the former case that uses granular catalysts.

In many cases, a target fluid to be treated by such types of treatment apparatuses contains an inorganic substance (including an inorganic solid). The inorganic substance becomes solid and precipitates in the reactor.

Specific examples of the inorganic substance include alumina, silica, zirconia, phosphate, nitrate, sulfate, and the like.

Superheated water and supercritical water have high dissolving power for organic substances but low dissolving power for inorganic substances.

As illustrated in FIG. 2A, a narrow region Sa is inevitably formed between the granular catalysts 102.

The inorganic substance precipitated in the reactor adheres to and accumulates on the surfaces of the catalysts 102 as well as accumulates in the narrow region Sa.

As illustrated in FIG. 2B, an inorganic substance 108 accumulated in the narrow region Sa grows into an aggregate with time and plugs the region where the target fluid passes through.

The case of using the honeycomb structural catalyst has the same problem that the flow path is plugged with the accumulated inorganic substance in the early stages and a target fluid cannot be treated for a long period of time, although being advantageous over the case of using the granular catalysts in view of the fact that a time until the flow path is plugged is longer.

In particular, the inorganic substance intensively adheres to the upstream-side end surface of the honeycomb structural catalyst, relative to the direction of flow of the fluid, because the upstream-side end surface is at a right angle to the direction of flow of the fluid. The accumulated inorganic substance blocks adsorbed to the catalyst grow toward the center of the outlet of each tube and consequently plug the outlets.

In a case in which the inorganic substance has accumulated in the reactor, the reactor needs cleaning.

Specifically, the cleaning requires the processes of suspending a treatment reaction, cooling a reaction system to normal temperature, opening the reactor by a worker, and removing the adhered inorganic substance from the reactor.

The smaller the inner diameter of the reactor becomes, the faster the inorganic substance accumulates, and the more frequently the maintenance of the reactor is performed.

As the maintenance of the reactor is performed more frequently, the treatment efficiency lowers and the running cost drastically increases with imposing a great labor on the worker.

In a case in which the inorganic substance is firmly adsorbed to the catalyst with a large force, it may be impossible to remove the inorganic substance from the reactor. In such a case, it is possible to reproduce the reactor by removing the catalyst layer to which the inorganic substance is adhered and forming a new catalyst layer. However, this procedure has a problem of wasting catalyst and time.

### SUMMARY

In accordance with some embodiments of the present invention, a fluid treatment apparatus for treating a target fluid is provided. The fluid treatment apparatus includes a reactor to decompose an organic substance contained in a mixed fluid of the target fluid with an oxidant by an oxidation reaction. The reactor includes a cylindrical base material, a catalyst, and a migration space. The catalyst accelerates the oxidation reaction of the organic substance, and is disposed along an inner periphery of the cylindrical base material. Into the migration space, solids precipitated in the oxidation reaction migrate in a longitudinal direction without accumulating.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIGS. 1A and 1B are lateral cross-sectional views of conventional reactors in which granular catalysts and a honeycomb structural catalyst are arranged, respectively;

FIGS. 2A and 2B are schematic views for explaining an accumulation mechanism of inorganic substances, illustrating a narrow region formed between granular catalysts where inorganic substances are likely to accumulate (FIG. 2A) and how inorganic substance accumulate in the narrow region (FIG. 2B), respectively;

FIGS. 3A and 3B are schematic views for explaining variation in the ratio of inner surface area to inner volume with respect to reaction tubes varied in inner diameter;

FIG. 4 is a schematic view of a fluid treatment apparatus according to a first embodiment of the present invention;

FIG. 5 is a schematic cross-sectional view of a reactor in the fluid treatment apparatus of FIG. 4;

FIG. 6 is an exaggerated cross-sectional view of covering layers provided in the reactor;

FIG. 7 is a schematic cross-sectional view of a reactor according to a second embodiment of the present invention;

FIG. 8 is a schematic cross-sectional view of a conventional catalyst-filled reactor;

FIG. 9 is a schematic cross-sectional view showing measurement points for a temperature distribution measurement test in a reactor;

FIG. 10 is a graph showing temperature variations measured in the measurement test; and

FIG. 11 is a schematic view of a fluid treatment apparatus according to a third embodiment of the present invention;

### DETAILED DESCRIPTION

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

For the sake of simplicity, the same reference number will be given to identical constituent elements such as parts and materials having the same functions and redundant descriptions thereof omitted unless otherwise stated.

JP-4986174-B proposes a reaction tube for use in microreactor, the inner periphery of which is covered with a thin film of a noble metal catalyst.

It is described therein that the inner diameter of the reaction tube is equal to or less than 1 mm.

According to this reaction tube, the catalyst is theoretically located on an outer-periphery side of the flow path for a target fluid. There is no factor which causes inorganic substances to accumulate in the flow path.

The reason that the reaction tube has an inner diameter equal to or less than 1 mm is to cause a prompt and highly-efficient interface reaction, as described in JP-4986174-B.

Such a flow path having an inner diameter equal to or less than 1 mm has a relatively large inner volume (i.e., the volume of the flow path inside the reaction tube) compared to the inner surface area (i.e., the area of the inner periphery of the reaction tube). Therefore, most of a target fluid having flowed into the reaction tube causes an interface reaction with the catalyst.

In other words, the flow path is so fine that most of the target fluid is brought into contact with the catalyst simultaneously.

Referring to FIGS. 3A and 3B, a reaction tube 110 having an inner diameter of 1 mm and a height of 100 mm and another reaction tube 112 having an inner diameter of 30 mm and a height of 100 mm are compared in terms of inner surface area (a), inner volume (b), and the ratio (a/b).

With respect to the reaction tube 110 illustrated in FIG. 3A, corresponding to the above-described reaction tube for microreactor, the inner surface area (a) is 1.0×3.14×100=314 mm², the inner volume (b) is 0.5×0.5×3.14×100=78.5 mm³, and the ratio (a/b) is 4. With respect to the reaction tube 112 illustrated in FIG. 3B, the inner surface area (a) is 30×3.14×100=9,420 mm², the inner volume (b) is 15×15×3.14×100=70,650 mm³, and the ratio (a/b) is 0.13.

The ratio (a/b) for the reaction tube 110 is overwhelmingly larger than that for the reaction tube 112, i.e., about 31 times that for the reaction tube 112.

Only when the ratio (a/b) is equal to or greater than a predetermined value, i.e., when the inner diameter is equal to or less than 1 mm, the reaction tube can be used for microreactor.

In other words, when the inner diameter exceeds 1 mm, the reaction tube cannot be expected to cause a highly-efficient interface reaction.

This is because the amount of fluid which will not contact the catalyst increases and thereby decrease the treatment efficiency.

A case in which a target fluid including an inorganic substance is treated by the reaction tube for use in microreactor is discussed below. When the inner diameter is equal to or less than 1 mm, even when no factor exists which causes the inorganic substance to accumulate in the flow path, it is apparent that the reaction tube will be plugged with the accumulated inorganic substance in the early stages because the flow path is too narrow.

Because the inner diameter is extremely small, i.e., equal to or less than 1 mm, the target fluid is very close to the catalyst and an oxidation is easily caused.

At the same time, the precipitated inorganic substance is very close to the catalyst layer during the treatment.

Accordingly, the precipitated inorganic substance is brought into contact with the catalyst layer more frequently, resulting in adherence of the inorganic substance to the inner surface of the reactor.

Because the inorganic substance will cover the surface of the catalyst and plug such a fine reaction tube with an inner diameter equal to or less than 1 mm in the radial direction in the early stages, a target fluid cannot be treated for a long period of time even when no catalyst exists which will narrow the flow path.

As the inner diameter of the reactor is increased, the target fluid contacts the catalyst only at an outer-periphery side of the flow path. This means that most of the target fluid migrates through the reactor without contacting the catalyst.

Actually, a reactor with such a configuration that the inner diameter is elongated for arranging catalysts on the inner periphery is extremely poor at treatment efficiency.

It has been considered that the reactor with such a configuration that catalysts are arranged on the inner periphery can be applied only to the field of microreactor in which interface reactions are assumed to occur in the entire part of the flow path.

Accordingly, in the fields other than the field of microreactor, another type of reactor has been employed with such a configuration that catalysts are arranged so as to inhibit flow of the target fluid and to enhance contact efficiency.

However, to a greater or lesser extent, this configuration cannot avoid the problem of poor maintainability of the reactor caused by accumulation of the inorganic substance.

In view of this situation, one object of the present invention is to provide a fluid treatment apparatus which can achieve a low level of maintenance frequency, reduced running cost, and reduced labor.

The inventors of the present invention have made the following prediction in the process of embodying the present invention.

Even when a target fluid is introduced into a reactor in a liquid state, the target fluid transforms into a gaseous state as the temperature is raised in accordance with the occurrence of an oxidation reaction in the reactor.

As the target fluid becomes gaseous, the mass transfer rate is increased. Accordingly, even when a catalyst is arranged on an inner-periphery side of the reactor, the target fluid can come into contact with the catalyst more frequently, and the treatment will be completed before the target fluid discharges from the reactor.

Thus, it may be possible to practically perform a treatment operation even when the inner diameter of the reactor is elongated for arranging catalysts on an inner-periphery side of the reactor.

Accordingly, a novel fluid treatment apparatus for treating a target fluid is proposed. The fluid treatment apparatus includes a reactor to decompose an organic substance contained in a mixed fluid of the target fluid with an oxidant by an oxidation reaction. The reactor includes a cylindrical base material; a catalyst to accelerate the oxidation reaction of the organic substance, which is disposed along an inner periphery of the cylindrical base material; and a migration space into which solids precipitated in the oxidation reaction migrate in a longitudinal direction without accumulating.

The fluid treatment apparatus in accordance with some embodiments of the present invention can achieve a low level of maintenance frequency, reduced running cost, and reduced labor.

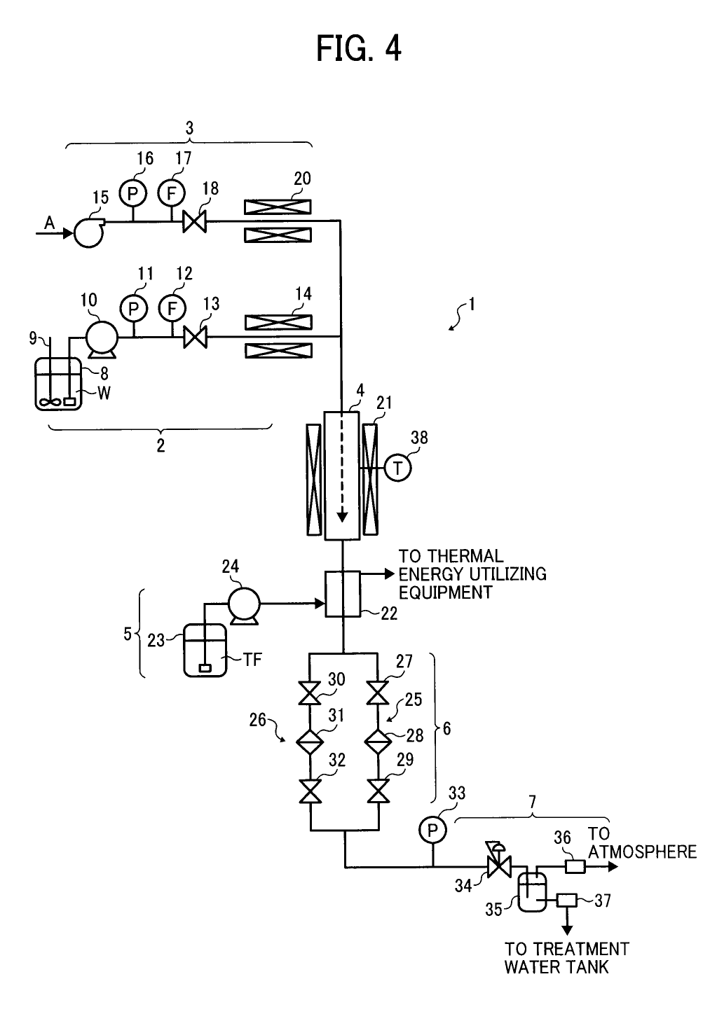

A fluid treatment apparatus according to a first embodiment of the present invention is described in detail with reference to FIGS. 4 to 6.

Referring to FIG. 4, a fluid treatment apparatus 1 includes a target fluid supply part 2, an oxidant supply part 3, a reactor 4, a heat exchange part 5, a solid separation part 6, a gas-liquid separation part 7, and a control part.

The target fluid supply part 2 has a raw water tank 8. The raw water tank 8 retains an untreated target fluid W including an organic substance.

The target fluid W is stirred by a stirrer 9 so that suspended solids (SS) are uniformly dispersed and the organic substance concentration is equalized therein.

The stirred target fluid W is pumped toward the reactor 4 by a raw water supply pump 10.

The pressure and flow rate of the target fluid W being pumped are detected by a raw water pressure gauge 11 and a raw water flow meter 12, respectively.

The flow rate of the target fluid W is adjustable by a raw water inlet valve 13. The raw water inlet valve 13 functions as a check valve. The raw water inlet valve 13 allows the target fluid W pumped from the raw water supply pump 10 to flow from a raw-water-supply-pump-10 side to a reactor-4 side while preventing the target fluid W from flowing in the opposite direction.

The target fluid W having passed through the raw water inlet valve 13 is preheated by a raw water preheater 14 disposed surrounding the flow path for the target fluid W.

The oxidant supply part 3 has an oxidant feed pump 15 composed of a compressor.

The oxidant feed pump 15 pumps an air A that is incorporated as an oxidant toward the reactor 4 while compressing the air A to a pressure similar to that of the target fluid W.

The pressure and flow rate of the air A being pumped are detected by an oxidant pressure gauge 16 and an oxidant flow meter 17, respectively.

An oxidant inlet valve 18 functions as a check valve. The oxidant inlet valve 18 allows the air A pumped from the oxidant feed pump 15 to flow from an oxidant-feed-pump-15 side to a reactor-4 side while preventing the air A from flowing in the opposite direction.

The air A having passed through the oxidant inlet valve 18 is preheated by an oxidant preheater 20 disposed surrounding the flow path for the air A.

The target fluid W preheated by the raw water preheater 14 merges with the air A preheated by the oxidant preheater 20 to become a mixed fluid. The mixed fluid pours into the reactor 4.

Accordingly, the raw water preheater 14 is disposed upstream from the reactor 4 relative to the direction of pouring of the target fluid W.

The pressures for pumping the target fluid W and the air A are adjusted to a pressure similar to the inner pressure of the reactor 4.

In the present embodiment, the target fluid and the oxidant become a mixed fluid before pouring into the reactor 4. Alternatively, the target fluid and the oxidant may be separately introduced into the reactor 4 via separate paths and then become a mixed fluid in the reactor 4.

The quantity of the air A pumped by the oxidant feed pump 15 is determined based on the stoichiometric quantity of oxygen needed for completely oxidizing the organic substance in the target fluid W.

More specifically, the stoichiometric quantity of oxygen needed for complete oxidization of the organic substance is calculated based on the concentrations of total organic carbon (TOC), total nitrogen (TN), and total phosphor (TP) in the target fluid W.

The quantity of the air A to be pumped is determined based on the calculation result. In particular, the quantity of the air A to be pumped is adjusted in such a manner that oxygen in an amount of from 1.0 to 3.0 times the stoichiometric quantity of oxygen needed for complete oxidization of the organic matter can be introduced.

Specific examples of the oxidant include air, oxygen, liquid oxygen, ozone, hydrogen peroxide, and combinations thereof.

A pressure applied to the mixed fluid in the reactor 4 may be in the range of 0.5 to 30 MPa, more preferably 5 to 15 MPa.

The inner pressure of the reactor 4 is adjustable by an outlet valve 34. The outlet valve 34 automatically opens to discharge the mixed fluid from the reactor 4 when the inner pressure of the reactor 4 exceeds a threshold. Thus, the inner pressure of the reactor 4 is kept constant at around the threshold.

The outer periphery of the reactor 4 is covered with a heater 21 for heating the mixed fluid in the reactor 4.

The temperature of the mixed fluid in the reactor 4 is raised not only by heat applied from the heater 21 but also by heat generated in an oxidation of the organic substance.

When the target fluid W includes an organic substance at high concentrations, the temperature of the mixed fluid may be raised to a desired value only by a large amount of heat generated in an oxidation of the large amount of the organic substance.

In such a case, it is possible that the raw water preheater 14, oxidant preheater 20, and heater 21 are put into operation only at the time the apparatus is switched on, and then switched off upon initiation of the oxidation.

The temperature of the mixed fluid in the reactor 4 may be in the range of 100° C. to 600° C., more preferably 200° C. to 550° C.

The temperature is adjustable by adjusting the outputs of the heater 21, raw water preheater 14, and oxidant preheater 20.

A temperature of 374.2° C. or more and a pressure of 22.1 MPa or more are respectively in excess of the critical temperature and pressure of both water and the air. When such temperature and pressure conditions are employed, the mixed fluid becomes a supercritical fluid that has an intermediate property between a liquid and a gas.

In the supercritical fluid, the oxidation of the organic substance progresses quickly because the organic substance is well soluble in the supercritical fluid and well makes contacts with the air.

Alternatively, a temperature of 200° C. or more (preferably 374.2° C. or more) and equal to or less than that of the saturated vapor, and a pressure of less than 22.1 MPa (preferably 10 MPa or more) and equal to or less than that of the saturated vapor, which is relatively high, may be employed, to put the target fluid in the mixed fluid into a superheated water in the reactor 4.

The temperature of the mixed fluid in the reactor 4 may be in the range of 100° C. to 700° C., more preferably 200° C. to 550° C.

At the time the fluid treatment apparatus 1 is put into operation, the mixed fluid in the reactor 4 is pressurized but the temperature thereof has not raised so high.

Thus, at the start of operation of the the fluid treatment apparatus 1, the heater 21 also starts heat generation to raise the temperature of the mixed fluid in the reactor 4 to the range of 200° C. to 550° C.

In the reactor 4, the mixed fluid is put into a high-temperature and high-pressure state to accelerate an oxidation of the organic substance and ammonia nitrogen contained therein.

In the mixed fluid having reached an end of a catalyst layer (to be described later) relative to the direction of feed of the fluid in the reactor 4, the organic substance is almost completely oxidized.

The detailed configuration of the reactor 4 and mechanism of accelerating oxidation by catalyst are described later.

The treated fluid discharged from the reactor 4 then flows into a heat exchanger 22 in the heat exchange part 5.

The heat exchange part 5 has a heat medium tank 23 retaining a heat exchange fluid TF.

The heat exchange fluid TF is supplied to the heat exchanger 22 by a heat exchange pump 24.

The heat exchange fluid heated by the heat exchanger 22 is fed to a thermal energy utilizing equipment through a piping.

Specific examples of the thermal energy utilizing equipment include, but are not limited to, a power generator.

The power generator generates power by rotating a turbine by means of an air current which is generated when the heat exchange fluid, the pressure of which has been increased by application of heat, transits from a liquid state to a gaseous state.

A part of the heat exchange fluid passed through the heat exchanger 22 may be fed to a branched piping to be used for preheating of the target fluid W and/or the air A.

The heat exchanger 22 draws heat from the treated fluid. Thus, moisture in the fluid is cooled, and the fluid transits from a supercritical or superheated vapor state to a liquid state. The fluid in a liquid state enters the solid separation part 6.

On the other hand, oxygen and nitrogen in the mixed fluid transit from a supercritical state to a gaseous state.

The solid separation part 6 includes a first separation system 25 and a second separation system 26.

The first separation system 25 includes a first branch valve 27, a first separation filter 28, and a first drain valve 29.

Similarly, the second separation system 26 includes a second branch valve 30, a second separation filter 31, and a second drain valve 32.

Solid oxides precipitated in the reactor 4 are caught by the first separation filter 28 or the second separation filter 31.

The first separation system 25 and the second separation system 26 are used alternately.

When the first separation system 25 is in use, the valves in the second separation system 26 are closed. When the second separation system 26 is in use, the valves in the first separation system 25 are closed.

As the first separation filter 28 or the second separation filter 31 is plugged, an outlet pressure gauge 33 measures a change in pressure. In accordance with the measurement result, washing or replacement of the first separation filter 28 or the second separation filter 31 is performed.

The gas-liquid separation part 7 includes the outlet valve 34 and a gas-liquid separator 35.

The mixed fluid passed through the solid separation part 6 is separated into the treated water and a gas by the gas-liquid separator 35.

The composition of the gas separated by the gas-liquid separator 35 is detected by a gas chromatographic detector 36.

When the gas chromatographic detector 36 detects an undecomposed substance, an alarm is raised upon reception of an output signal from the gas chromatographic detector 36. The TOC concentration in the liquid separated by the gas-liquid separator 35 is detected by a TOC analyzer 37.

When the TOC analyzer 37 detects a TOC concentration in excess of a threshold, an alarm is raised upon reception of an output signal from the TOC analyzer 37.

In the treated water, even a low-molecular organic substance, which cannot be completely removed by a biological treatment using activated sludge, has been completely oxidized. Accordingly, the treated water contains little or no suspended substance or organic substance.

Thus, the treated water as it is can be reused as industrial water.

The treated water further being subjected to a filtering treatment using an ultrafiltration membrane can be used as an LSI washing liquid.

The gas separated by the gas-liquid separator 35 is composed primarily of oxygen dioxide, nitrogen gas, and oxygen.

Immediate downstream from the heat exchanger 22, a heat exchanger outlet thermometer is provided to detect the temperature of the liquid.

The heat exchange pump 24 is drive-controlled so that the detection result by the heat exchanger outlet thermometer falls within a predetermined range.

When the detection result by the heat exchanger outlet thermometer reaches a predetermined upper-limit temperature, the drive quantity of the heat exchange pump 24 is increased to increase the supply of the heat exchange fluid to the heat exchanger 22, thereby enhancing the cooling function of the heat exchanger 22.

When the detection result by the heat exchanger outlet thermometer reaches a predetermined lower-limit temperature, the drive quantity of the heat exchange pump 24 is reduced to reduce the supply of the heat exchange fluid to the heat exchanger 22, thereby lowering the cooling function of the heat exchanger 22.

By the above control, the heat exchange quantity is appropriately adjusted and the treated fluid is kept at a constant temperature.

The heat exchanger 22 may be directly installed in the reactor 4.

When the organic substance concentration in the target fluid W is relatively high, a large amount of heat generates in an oxidation of the organic substance. In this case, the raw water preheater 14, oxidant preheater 20, and heater 21 are put into operation only in the early stages. After the oxidation of the organic substance has initiated, the heat generated in the oxidation of the organic substance is used for the control.

In particular, the temperature of the mixed fluid of the target fluid W with the air A can be spontaneously raised to a predetermined temperature owing to the heat generated in the oxidation of the organic substance.

The control part controls the raw water preheater 14, oxidant preheater 20, and heater 21 to reduce output power or stop operation when a detection result by a reactor thermometer 38 that detects the temperature of the reactor 4 exceeds a predetermined temperature.

Thus, wasteful energy use is suppressed.

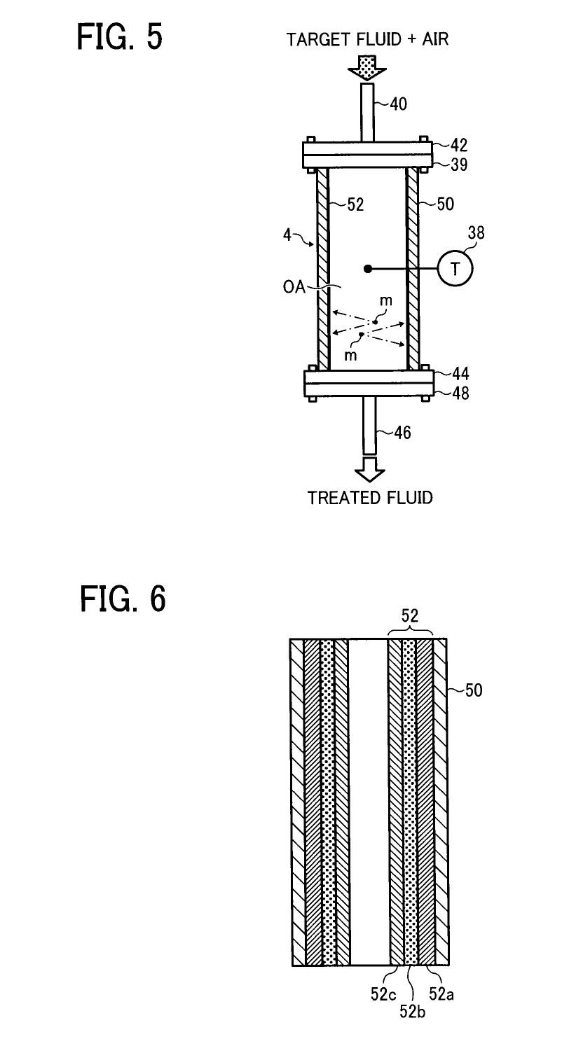

The configuration of the reactor 4 is described in detail with reference to FIG. 5.

On an upper vertical end of the reactor 4, a flange 39 having an opening is fixed. The flange 39 is hermetically bonded with a flange 42 having a pouring port 40 for pouring the mixed fluid of the target fluid W with the air A.

On a lower vertical end of the reactor 4, a flange 44 having an opening is fixed. The flange 44 is hermetically bonded with a flange 48 having a discharge port 46 for discharging the treated fluid.

The reactor 4 includes a cylindrical base material 50 and a covering layer 52 covering the inner periphery of the base material 50.

As illustrated in FIG. 6, the covering layer 52 includes a corrosion-resistant layer 52a covering the inner periphery of the base material 50, an intermediate layer 52b covering the corrosion-resistant layer 52a, and a catalyst layer 52c covering the intermediate layer 52b.

The thickness of the covering layer 52 is several millimeters (e.g., 2 mm) in actual, although exaggeratedly illustrated in FIG. 6.

The base material 50 is composed of a pressure-resistant metallic material. Specific examples of such metallic material include, but are not limited to, stainless steels (e.g., SUS304, SUS316), Inconel® 625, and nickel alloys.

The inner pressure of the reactor 4 is controlled to be in the range of 0.5 to 30 MPa, preferably 5 to 15 MPa.

The base material 50 has a thickness resistant to such high inner pressures.

The corrosion-resistant layer 52a is composed of a corrosion-resistant material such as titanium, titanium alloy, nickel alloy, tantalum, iridium, and platinum.

In some cases, in the reactor 4, hydrochloric acid derived from chloro groups in organic chlorides, organic acids such as sulfuric acid and nitric acid derived from sulfonyl groups in amino acid, or hydrofluoric acid generate. Such substances make the mixed fluid strongly acidic.

In some situations, the mixed fluid becomes very strongly acidic and becomes capable of dissolving the metallic base material 50 in a very short time period.

The dissolved base material 50 cannot withstand high pressures and may result in rupture. In view of this situation, the inner wall of the base material 50 is covered with the corrosion-resistant layer 52a having excellent corrosion resistance. The corrosion-resistant layer 52a prevents the base material 50 from corrosion.

The catalyst layer 52c is composed of a material capable of accelerating oxidation of the organic substance, such as a compound containing at least one of Au, Pd, Ag, Pt, Ru, Co, Ni, Cu, Mn, Fe, V, Ti, and Cr.

The intermediate layer 52b is composed of a material which exhibits an adherence to the corrosion-resistant layer 52a greater than that of the catalyst layer 52c, and an adherence to the catalyst layer 52c greater than that of the corrosion-resistant layer 52a.

In the present embodiment, the corrosion-resistant layer 52a is composed of titanium, and the catalyst layer 52c is composed of palladium.

The intermediate layer 52b is composed of gold, which exhibits an adherence to titanium greater than that of palladium, and an adherence to palladium greater than that of titanium.

Owing to the presence of the intermediate layer 52b between the corrosion-resistant layer 52a and the catalyst layer 52c, the catalyst layer 52c, composed of a catalytic material that accelerates oxidation of the organic substance, can be reliably adhered to the corrosion-resistant layer 52a, composed of a corrosion-resistant material, for an extended period of time.

Thus, loss of catalytic ability caused by omission of the catalyst layer 52c is avoided.

Specific methods of covering the inner periphery of the base material 50 with the corrosion-resistant layer 52a include, but are not limited to, explosive welding. Explosive welding is a process where different types of materials are firmly bonded by accelerating the materials at a high velocity to make them collide with each other through the use of explosive force.

It is possible that the catalyst layer 52c directly covers the corrosion-resistant layer 52a. In this case, a material composing the catalyst layer 52c is stacked on the surface of the corrosion-resistant layer 52a through the process of CVD method, dipping method, reduction method, plating method, or spraying method.

However, for the purpose of preventing omission of the catalyst layer 52c, provision of the intermediate layer 52b is preferred.

In a case in which the base material 50 combines a function of the corrosion-resistant layer 52a, it is possible that the catalyst layer 52c is directly formed on the inner periphery of the base material 50.

Referring to FIGS. 5 and 6, the catalyst (catalyst layer 52c) that accelerates oxidation of the organic substance is arranged along the inner periphery of the reactor 4.

An internal space OA of the reactor 4 acts as a flow path for the mixed fluid as well as a migration space into which an inorganic substance precipitated in the oxidation reaction migrates.

The internal space as a whole acts as the migration space. No obstacle exists which intercepts migration of the target fluid and makes the inorganic substance accumulate thereon.

Because the reactor 4 is vertically extended, the inorganic substance that is solid migrates by falling down by its own weight.

As the inner diameter of the reactor 4 becomes larger, it becomes more likely that the inorganic substance which precipitated at a portion in the reactor 4 where water becomes a gaseous phase down to a lower part of the reactor 4 by its own weight before reaching the inner wall (catalyst layer 52c) of the reactor 4.

This is simply because the distance between the portion where the inorganic substance precipitated and the inner wall of the reactor 4 becomes larger.

The organic substance in the target fluid gasifies at a portion in the reactor 4 where water becomes a high-temperature and high-pressure gaseous phase, and its mass transfer rate increases. Thus, the organic substance becomes capable of contacting the catalyst layer 52c provided on the inner wall of the reactor 4 to be subjected to an oxidation.

By contrast, the inorganic substance does not gasify and its mass transfer rate does not increase. Thus, the inorganic substance is more likely to fall down to a lower part of the reactor 4 by its own weight than to reach the inner wall of the reactor 4.

In FIG. 5, arrows indicate the direction of feed of the mixed fluid of the target fluid W with the air A. The target fluid W generally pours into the reactor 4 in a liquid state (at a pressure of 10 MPa and a temperature ranging from room temperature to about 300° C.).

The target fluid W receives heat from the environment (e.g., combustion heat generated in the oxidation of the organic substance, heat generated by the preheaters) while passing through the reactor 4 and thereby transits from a liquid state to a gaseous state.

As described above, at the gaseous-phase portion in the reactor 4, the organic substance in the target fluid W drastically increases its mass transfer rate to the level of that of gas molecule, thereby dramatically increasing the possibility that the organic substance comes into contact with the catalyst layer 52c.

As schematically illustrated in FIG. 5, an organic substance molecule m randomly moves at a high velocity and comes into contact with the catalyst layer 52c even from a long distance.

The gasification of water in the target fluid W progresses at a high speed in a chain. Thus, the organic substance can be treated at a high speed and the treatment can be completed in a short time period.

The size of the reactor 4 is defined in terms of the direction of flow of the fluid, i.e., the axial or longitudinal direction. In particular, the distance between the portion where water in the target fluid W transits from a liquid state to a gaseous state in the reactor 4 and the outlet of the reactor 4 is longer than half of the inner diameter of the reactor 4.

The portion where water in the target fluid W transits from a liquid state to a gaseous state can be determined by, for example, monitoring change in temperature with a plurality of thermocouples provided in the reactor 4 at intervals in the vertical direction.

The treatment time (i.e., the time it takes the target fluid W to pass through the reactor 4) ranges from 2 seconds to 30 minutes.

The amount of the target fluid W to pour into the reactor 4 is adjusted in accordance with the treatment time.

As described above, no obstacle, such as granular or honeycomb-structural catalyst which prevents the inorganic substance from falling down by its own weight, exists in the internal space of the reactor 4.

Accordingly, a time until the inorganic substance adsorbed to the catalyst layer 52c prevents the treatment operation is drastically extended.

Thus, the frequency of removing the adhered inorganic substance from the catalyst layer 52c is drastically reduced, thereby saving the effort of cleaning the reactor 4.

In the above-described embodiment, water in the target fluid W is in a liquid state at the time the target fluid W is introduced into the reactor 4, and then becomes gaseous in the reactor 4. In a case in which the water becomes immediately gaseous at the time the target fluid W is introduced into the reactor 4, the treatment efficiency will increase.

In achieving such conditions, preheating temperature, solid content concentration (combustion heat), and flow rate of the target fluid W are important parameters.

The inner pressure of the reactor 4 and the preheating temperature for the target fluid W to be introduced into the reactor 4 are determined so that at least part of the water in the target fluid W becomes gaseous or supercritical in the reactor 4, based on the combustion heat quantity of the organic substance contained in the target fluid W.

This determination is done by the control part.

In the present embodiment, the inner diameter of the reactor 4 is equal to or greater than 10 mm.

This lower-limit inner diameter (i.e., 10 mm) is enough for securing a migration space into which solids are allowed to migrate in the axial direction (or fall down) without accumulating.

In other words, the lower-limit inner diameter is enough for effectively performing the oxidation treatment and extending the interval between inorganic substance removal operations.

To determine the lower-limit inner diameter of the reactor 4, the following experiments were conducted.

### Experiment Description

A circulation test was performed by feeding a dispersion liquid, in which 2% by weight of silica-alumina powder (i.e., inorganic substance) was dispersed in water, to a reactor heated with a heater to 400° C.

In the reactor, metallic tubes (having an inner diameter of 5 mm, 7 mm, and 10 mm) were arranged as a honeycomb structural catalyst to determine whether or not the degree of adherence of the inorganic substance depends on the diameter of the tubes.

### Experimental Conditions

Inner Temperature of Reactor: 400° C. (gaseous phase)

Inner Pressure of Reactor: 10 MPa

Outer Diameter of Reactor: ¾ inches

Circulation Time: 2.5 hours

Length of Reactor: 150 mm

Length of Metallic Tubes: 50 mm

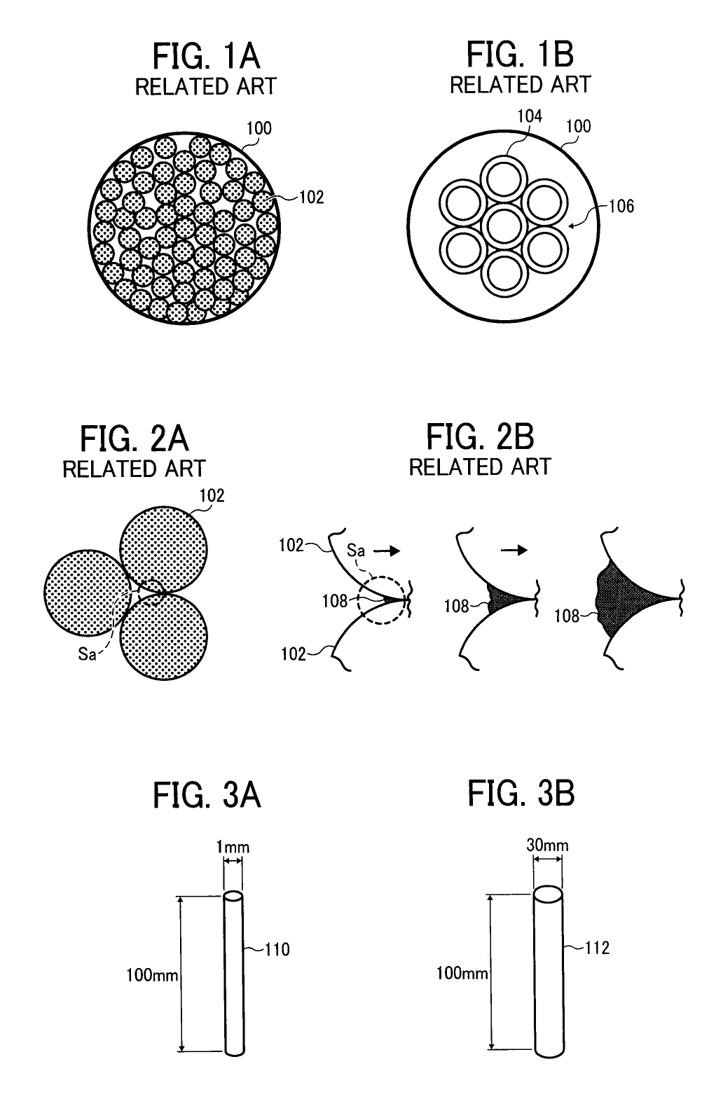

Example 1: A honeycomb structural catalyst which bundles seven metallic tubes having an inner diameter of 5 mm (corresponding to the example illustrated in FIG. 1B) was used.
Example 2: A honeycomb structural catalyst which bundles three metallic tubes having an inner diameter of 7 mm was used.
Example 3: One metallic tube having an inner diameter of 10 mm (corresponding to the second embodiment) was used.

Results

Example 1: The centrally-located metallic tube was plugged with the inorganic substance.
Example 2: The inorganic substance was slightly adhered to each metallic tube.
Example 3: The inorganic substance was not adhered to the metallic tube.

Example 1 corresponds to a conventional configuration. The lower-limit inner diameter of the reactor enough for extending the interval between inorganic substance removal operations is considered to exist at around 7 mm.

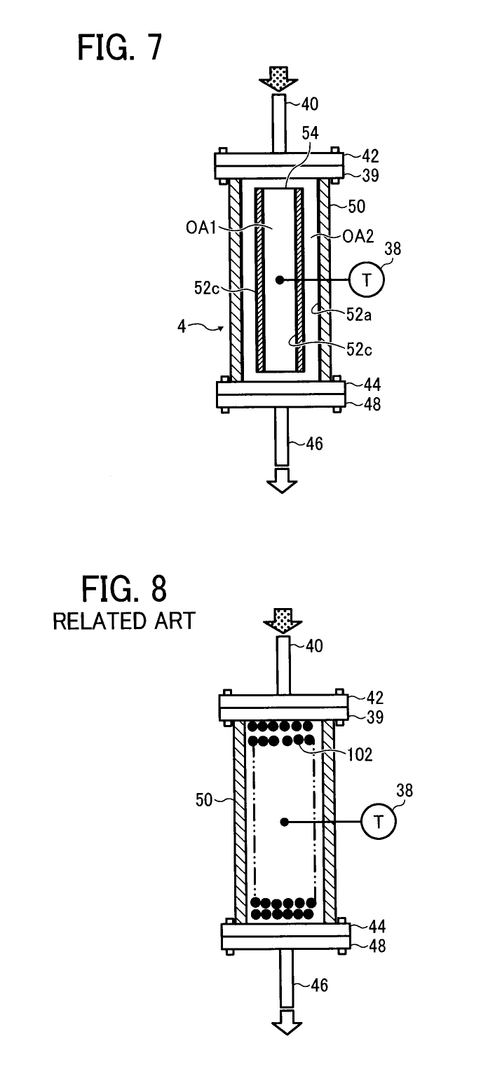

The second embodiment is described in detail with reference to FIG. 7.

For the sake of simplicity, the same reference number will be given to identical constituent elements such as parts and materials having the same functions and redundant descriptions thereof omitted unless otherwise stated.

In the reactor 4 according to the second embodiment, the inner periphery of the base material 50 is covered with the corrosion-resistant layer 52a, and a cylindrical catalyst member 54 is detachably disposed to the base material 50.

The internal space of the reactor 4 is concentrically divided into an inner space OA1 and an outer space OA2.

The cylindrical catalyst member 54 is composed of a cylindrical member. Both the inner and outer peripheries of the cylindrical member are covered with the catalyst layer 52c. In other words, each catalyst layers 52c is arranged in a ring-like shape along the inner periphery of the reactor 4 forming a gap therebetween.

The target fluid W is subjected to the catalytic action when passing through either the inner space OA1 or the outer space OA2.

The inner space OA1 and outer space OA2 each act as a migration space into which solids (e.g., inorganic substances) migrate.

Because of having the greater catalyst surface area, the second embodiment provides an oxidation treatment efficiency better than that of the first embodiment.

The size of the catalyst member 54 is such that only one piece of catalyst member 54 can be installed in the internal space of the reactor 4 and that no early accumulation of inorganic substances is caused in the outer space OA2.

Compared to the conventional configuration in which granular or honeycomb structural catalysts are arranged, the diameter of the inner space OA1 and the gap for the outer space OA2 are extremely large.

Accordingly, a time until the inorganic substance adhered to the catalyst layer 52c prevents the treatment operation is drastically extended.

In the present embodiment, inside the reactor 4 exists the catalyst member 54 to/on which inorganic substances will adhere/accumulate, which is not the case with the first embodiment.

However, the rate of adherence/accumulation of inorganic substances to/on an end surface of the cylindrical catalyst member 54 is extremely lower than that in the conventional configuration because only one piece of cylindrical catalyst member 54 exists without forming the narrow region Sa illustrated in FIGS. 2A and 2B.

The second embodiment also has an advantage over the first embodiment in the ease of adherent removal operation.

Since the catalyst member 54 is detachably disposed to the base material 50, it is possible to detach the catalyst member 54 from the base material 50 and subject it to the adherent removal operation. This procedure is much easier than subjecting the inner periphery of the reactor 4 to the adherent removal operation.

In a case in which it is difficult to remove the adhered inorganic substances from the catalyst member 54, it is possible to replace the catalyst member 54 with a new one, thereby easily recovering the catalytic function.

A fluid treatment apparatus including a reactor according to an embodiment of the present invention and another fluid treatment apparatus including a conventional reactor are subjected to a running test as follows.

### Example 1

A reactor having the configuration illustrated in FIG. 5 with an inner diameter of 150 mm and a length of 1,000 mm is used.

The flow rates of a target fluid, i.e., a model waste liquid (to be described later), and the air serving as an oxidant are adjusted such that the treatment time (i.e., the time it takes the target fluid to pass through the reactor) becomes 1 minute.

### Example 2

A reactor having the configuration illustrated in FIG. 7 is used. The other conditions are the same as those in Example 1.

### Comparative Example

A reactor having the configuration illustrated in FIG. 8 is used. This reactor consists of the base material 50, and the granular catalysts 102 are arranged throughout the whole internal space of the reactor.

The catalysts 102 are composed of granular manganese dioxide having a diameter of about 1 mm.

The other conditions are the same as those in Example 1 or 2.

The above three types of fluid treatment apparatuses (experimental apparatuses) are subjected to a running test under the same treatment conditions.

The model waste liquid is a solution prepared by dispersing 1% by weight of silica-alumina powder in an aqueous solution of 4% by weight of methanol.

The model waste liquid is preheated to 350° C. by the raw water preheater 14 and then poured into the reactor.

At this time, the heater 21 for heating the reactor is switched off.

The water treated by each of the above fluid treatment apparatuses is subjected to a measurement of TOC (total organic carbon) concentration. The measured value is checked whether it satisfies the discharge standard to rivers.

In addition, the weight ratio of the silica-alumina inorganic solids collected at the reactor or filter is checked.

The results are shown in Table 1.

TABLE 1

| | | Preheating | | | Inorganic | Inorganic |
|---|---|---|---|---|---|---|
| | MeOH | Temperature | | | Substance | Substance |
| | Concentration | of Model | Inner | Residual | Collection | Collection |
| | in Model | Waste | Temperature | TOC | Rate in | Rate at |
| | Waste Liquid | Liquid | of Reactor | Concentration | Reactor | Filter |
| Example 1 | 4% by weight | 350° C. | 500° C. | 10 ppm or | 0.02% | 99.98% |
| | | | | less | | |
| Example 2 | 4% by weight | 350° C. | 500° C. | 10 ppm or | 0.03% | 99.97% |
| | | | | less | | |
| Comparative | 4% by weight | 350° C. | 500° C. | 10 ppm or | 87.90% | 12.10% |
| Example | | | | less | | |

As a result of the running test in Examples 1 and 2, the inorganic solids slightly adhere to the surface of the catalyst layer in the reactor, but never cover the whole area of the inner wall of the reactor.

By contrast, as a result of the running test in Comparative Example, although the organic substance is burnt, the inorganic solids accumulate at interstices between the catalysts particularly provided on an upstream part.

The inner temperature of the reactor is 500° C. in each of Examples 1 and 2 and Comparative Example.

In every condition, the inner temperature of the reactor is higher than the raw water preheating temperature (i.e., the temperature of the model waste liquid). This indicates that the organic substance in the raw water is oxidation-composed and combustion heat is generated.

In each example, the TOC concentration in the treated water is equal to or less than 10 ppm, which satisfies the discharge standard to rivers.

This indicates that the treatment performance of the fluid treatment apparatus according to some embodiments of the present invention is comparable with that of the conventional fluid treatment apparatus.

It is confirmed by taking out the filter disposed downstream from the reactor after the running test that the inorganic solids adhere to the filter in each of Examples 1 and 2 and Comparative Example.

It is confirmed by comparing the weight of the inorganic solids remaining in the reactor and that adhered to the filter that 99.98% of the inorganic solids are collected by the filter in Example 1.

In Example 2, 99.97% of the inorganic solids are collected by the filter.

By contrast, in Comparative Example, only 0.1% of the inorganic solids reach the filter and most of the inorganic solids accumulate in the reactor.

Accordingly, in the reactor in accordance with an embodiment of the present invention, the frequency of removing inorganic solids can be drastically reduced compared to the conventional catalyst-filled reactor.

The above results show that the reactors in accordance with some embodiments of the present invention are prevented from being plugged with inorganic solids.

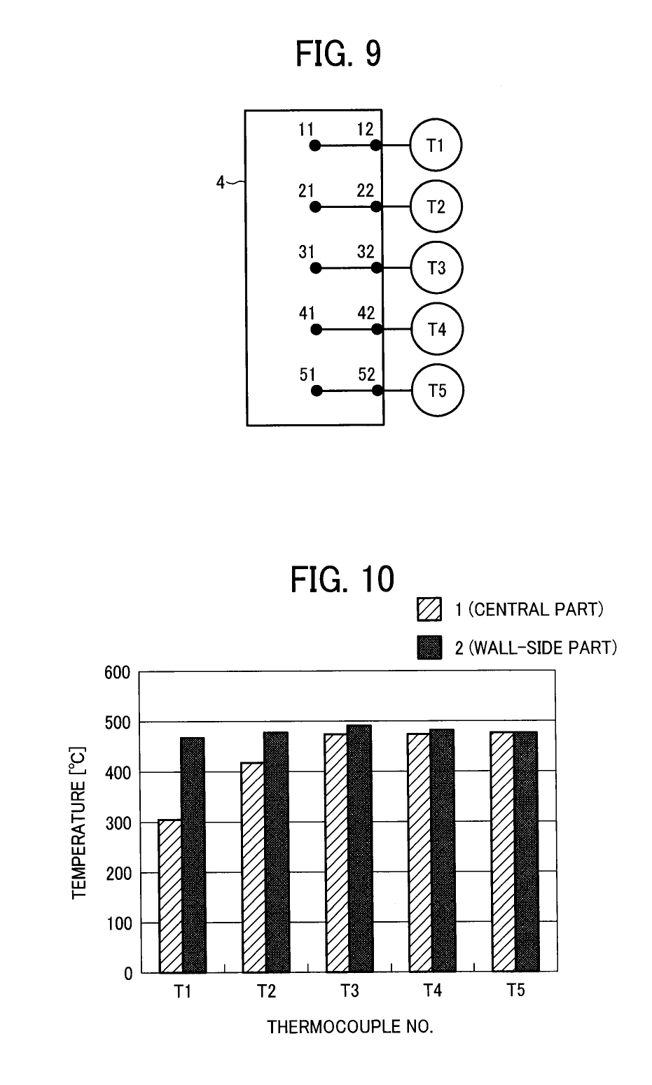

Next, an experimental apparatus having the same configuration as the fluid treatment apparatus used in Example 1 is prepared, and multipoint thermocouples are installed in its reactor at regular intervals as shown in FIG. 9.

The total number of the thermocouples is five. Each thermocouple measures temperature at two points, i.e., at a central part and a wall-side part in the reactor.

This experimental apparatus is subjected to a running test.

As a target fluid, a solution prepared by dispersing 1% by weight of silica-alumina powder in an aqueous solution of 6% by weight of methanol is used.

The target fluid is preheated to 300° C. by the raw water preheater 14 and then poured into the reactor.

During the running test, a temperature distribution in the reactor is measured.

The water in the target fluid is in a liquid state after the preheating in the running test. The result of the running test is shown in FIG. 10.

As shown in FIG. 10, at the central hallow parts of the reactor, the temperature is raised from the center toward a downstream side.

This is because a part of the organic substance is supplied with heat from the environment and subjected to an oxidation, thereby generating heat.

On the other hand, at the wall-side parts (the inner periphery) of the reactor on which the catalyst is arranged, a temperature of about 500° C. is measured. This indicates that the organic substance is effectively burnt owing to the presence of the catalyst. The TOC concentration in the treated fluid is about 10 ppm.

Even when water in the target fluid is in a liquid state at the time the target fluid is poured into the reactor, the water transits to a gaseous state owing to the combustion heat of the organic substance in the target fluid. This indicates that the organic substance has been effectively oxidized.

The results of this running test show that the reactor having such a wide diameter can perform sufficient treatment for the target fluid.

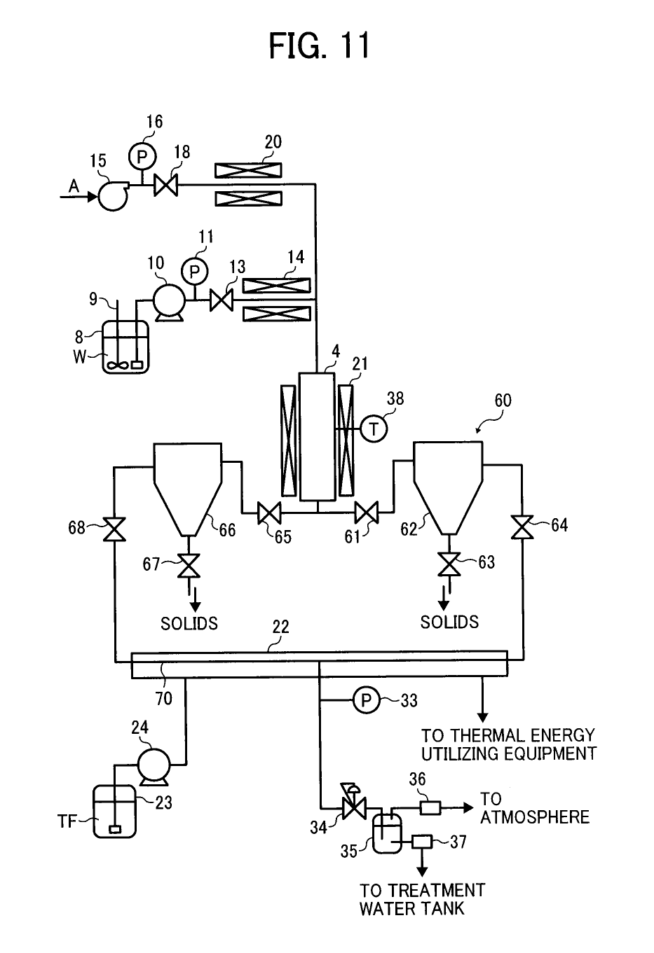

A third embodiment is illustrated in FIG. 11.

The reactor 4 has the same configuration as those used in the former embodiments. Only different points from the embodiment illustrated in FIG. 4 are described below.

In the third embodiment, a solid separator 60 is disposed upstream from the heat exchanger 22.

The solid separator 60 includes a first separation system and a second separation system. The first separation system includes a first branch valve 61, a first separation tank 62, a first drain valve 63, and a first sluice valve 64.

The second separation system includes a second branch valve 65, a second separation tank 66, a second drain valve 67, and a second sluice valve 68.

The first separation system and the second separation system are used alternately.

When the first separation system is in use, the first branch valve 61 and the first sluice valve 64 in the first separation systems are opened while the second branch valve 65 and the second sluice valve 68 in the second separation systems are closed.

When the second separation system is in use, the second branch valve 65 and the second sluice valve 68 in the second separation system are opened while the first branch valve 61 and the first sluice valve 64 in the first separation system are closed.

In the first separation system, the treated fluid fed from the reactor 4 enters the first separation tank 62 via the first branch valve 61.

In the first separation tank 62, solids in the treated fluid fall down toward the bottom of the tank by their own weight.

The treated fluid from which the solids have been separated discharges from the first separation tank 62 and then flows into a treated fluid feed pipe 70 via the first sluice valve 64.

For the purpose of more precisely separating solids from the fluid in the first separation tank 62, a filter can be provided to a fluid discharge outlet of the first separation tank 62.

When the first separation system is in use, the second branch valve 65 and the second sluice valve 68 are closed. Therefore, the second separation system is shut off from a path connecting the reactor 4, the first separation system, and the treated fluid feed pipe 70.

By opening the second drain valve 67 disposed immediately below the second separation tank 66 with the second separation system being shut off from the above path, solids accumulated at the bottom of the second separation tank 66 are discharged from the second separation tank 66.

The inner pressure of the second separation tank 66 decreases as the solids discharge. On the other hand, the above path maintains a high inner pressure because the second separation system is shut off therefrom.

Accordingly, it is possible to remove solids from the second separation tank 66 without suspending the treatment operation of the apparatus.

When the second separation system is in use, the treated fluid passed through the second branch valve 65 flows into the second separation tank 66 to be subjected to the solid separation treatment.

The treated fluid from which the solids have been separated discharges from the second separation tank 66 and then flows into the treated fluid feed pipe 70 via the second sluice valve 68.

In the first separation system, by opening the first drain valve 63, solids are discharged from the first separation tank 62.

In the treated fluid feed pipe 70, moisture in the treated fluid is cooled, and the fluid transits from a supercritical or superheated vapor state to a liquid state.

On the other hand, oxygen and nitrogen in the mixed fluid transit from a supercritical state to a gaseous state.

The mixed fluid passed through the treated fluid feed pipe 70 is separated into the treated water and a gas by the gas-liquid separator 35.

The treated fluid feed pipe 70 is equipped with the heat exchanger 22 on its outer surface.

The main body of the heat exchanger 22 is composed of an outer tube that is covering the outer surface of the treated fluid feed pipe 70. A space between the outer tube and the outer surface of the treated fluid feed pipe 70 is filled with a heat exchange fluid such as water.

Heat is exchanged between the outer surface of the treated fluid feed pipe 70 and the heat exchange fluid.

While the reactor 4 is in operation, a very-high-temperature liquid flows into the treated fluid feed pipe 70. Therefore, heat is transferred from the treated fluid feed pipe 70 to the heat exchange fluid in the heat exchanger 22, thereby heating the heat exchange fluid.

The direction of feed of the heat exchange fluid in the heat exchanger 22 is opposite to that of the liquid in the treated fluid feed pipe 70 so that countercurrent heat exchange is caused.

Namely, the heat exchange fluid is fed from an outlet-valve-34 side toward a solid-separator-60 side. In particular, the heat exchange pump 24 sucks the heat exchange fluid from the heat medium tank 23 and feeds it to the heat exchanger 22.

What is claimed is:

1. A fluid treatment apparatus for treating a target fluid, comprising:
a reactor to decompose an organic substance contained in a mixed fluid of the target fluid with an oxidant by an oxidation reaction, including:
a cylindrical base material;
a catalyst to accelerate the oxidation reaction of the organic substance, the catalyst disposed along an inner periphery of the cylindrical base material; and
a migration space into which solids precipitated in the oxidation reaction migrate in a longitudinal direction without accumulating.

2. The fluid treatment apparatus according to claim 1,
wherein the catalyst is disposed on the inner periphery of the cylindrical base material, and
wherein the migration space includes an entirety of an internal space of the reactor.

3. The fluid treatment apparatus according to claim 2, wherein the reactor further includes:
a corrosion-resistant layer stacked on the inner periphery of the cylindrical base material, the corrosion resistant layer including a material more corrosion-resistant than the cylindrical base material;
an intermediate layer stacked on the corrosion-resistant layer, the intermediate layer including a material having an adherence to the corrosion-resistant layer greater than that of the catalyst layer and having an adherence to the catalyst layer greater than that of the corrosion-resistant layer; and
a catalyst layer stacked on the intermediate layer, the catalyst layer including the catalyst.

4. The fluid treatment apparatus according to claim 1, wherein the reactor further includes:
a longitudinally-extended cylindrical catalyst member dividing the internal space of the reactor into an inner space and an outer space,
wherein the migration space includes both the inner space and the outer space.

5. The fluid treatment apparatus according to claim 1, further comprising:
a heater to heat the target fluid, the heater disposed upstream from the reactor relative to a direction of introduction of the target fluid into the reactor,
wherein an inner pressure of the reactor and a preheating temperature of the target fluid to pour into the reactor are set such that at least part of water contained in the target fluid is in a gaseous or supercritical state in the reactor.

6. The fluid treatment apparatus according to claim 1, wherein a distance between a portion where water in the target fluid transits from a liquid state to a gaseous state in the reactor and an outlet of the reactor is longer than half of an inner diameter of the reactor.

7. The fluid treatment apparatus according to claim 1, wherein the reactor has an inner diameter equal to or greater than 10 mm.

8. The fluid treatment apparatus according to claim 1, wherein an amount of the target fluid to pour into the reactor is adjusted such that a time it takes the target fluid to pass through the reactor ranges from 2 seconds to 30 minutes.

9. The fluid treatment apparatus according to claim 3, wherein the material included in the corrosion-resistant layer is selected from the group consisting of titanium, titanium alloy, nickel, nickel alloy, tantalum, iridium, and platinum.

10. The fluid treatment apparatus according to claim 1, wherein the cylindrical base material of the reactor is selected from the group consisting of stainless steel and nickel alloy.

11. The fluid treatment apparatus according to claim 1, wherein the catalyst includes a compound containing at least one member selected from the group consisting of Au, Pd, Ag, Pt, Ru, Co, Ni, Cu, Mn, Fe, V, Ti, and Cr.

12. The fluid treatment apparatus according to claim 4, wherein the catalyst member includes a surface material including a compound containing at least one member selected from the group consisting of Au, Pd, Ag, Pt, Ru, Co, Ni, Cu, Mn, Fe, V, Ti, and Cr.

13. The fluid treatment apparatus according to claim 1, further comprising:
an oxidant feed pump to pump the oxidant to the reactor,
wherein the oxidant is selected from the group consisting of air, oxygen, liquid oxygen, ozone, and hydrogen peroxide.

14. The fluid treatment apparatus according to claim 1, further comprising:
a heat exchanger to utilize heat generated in the reactor or heat carried by the treated target fluid discharged from the reactor as thermal energy.
